(19) United States
(12) Patent Application Publication
(10) Pub. No.: US 2023/0027748 A1
(43) Pub. Date: Jan. 26, 2023

(54) ALTERNATIVE CURRENT SOCKET DEVICE

(71) Applicant: Wistron Corporation, New Taipei City (TW)

(72) Inventors: Yun-Hsiu Hsu, New Taipei City (TW); Ching-Hung Su, New Taipei City (TW); Yi-Jun Lee, New Taipei City (TW)

(73) Assignee: Wistron Corporation, New Taipei City (TW)

(21) Appl. No.: 17/486,945

(22) Filed: Sep. 28, 2021

(30) Foreign Application Priority Data
Jul. 21, 2021 (TW) 110126725

(51) Int. Cl. H01R 13/66; H01R 24/68; H01R 24/30

(52) U.S. Cl. CPC H01R 13/665; H01R 24/30; H01R 24/68

(57) ABSTRACT

An alternating current (AC) inlet device for an electronic device includes a socket; a slot; a conductive plug module, connected to an AC current; and a steel piece, comprising a main part, a first extension part and a second extension part, wherein the main part is fixed on an exterior of the socket by a fixing element on a shell of the socket, and the first extension part and the second extension part are electrically connected to a conducting point of the electronic device.

### BACKGROUND OF THE INVENTION

### 1. Field of the Invention

The present invention relates to an alternative current socket device, and more particularly, to an alternative current socket device capable of increasing an upper limit of a short-circuit current capacity.

### 2. Description of the Prior Art

In order to satisfy requirements of increasing efficiency, electromagnetic interference (EMI) layers and preventing electrostatic discharge (ESD), the International Electrotechnical Commission has introduced the IEC/EN 62368-1 standard, wherein a testing condition of a short-circuit current for an alternative current socket is increased to 1500 amperes (A) to improve the safety of electronic devices.

The conventional technique utilizes Kelly wires or copper traces on the power circuit board to protect an earth conductor of the AC socket. Utilizing Kelly wires requires extra Kelly wires thereby increasing manufacturing costs, and utilizing copper traces requires extra screws and screw studs to connect the AC socket to the copper traces on the power circuit board, restricting the position of the AC socket installed on the electronic device.

Therefore, how to protect the earth conductor and increase an upper limit of the short-circuit current is an important issue in the art.

### SUMMARY OF THE INVENTION

In light of this, the present invention provides an alternative current socket device to protect an earth conductor and increase an upper limit of a short-circuit current.

An embodiment of the present invention discloses an alternating current (AC) inlet device for an electronic device. The AC inlet device comprises: a socket; a slot; a conductive plug module, connected to an AC current; and a steel piece, comprising a main part, a first extension part and a second extension part, wherein the main part is fixed on an exterior of the socket by a fixing element on a shell of the socket, and the first extension part and the second extension part are electrically connected to a conducting point of the electronic device.

These and other objectives of the present invention will no doubt become obvious to those of ordinary skill in the art after reading the flowing detailed description of the preferred embodiment that is illustrated in the various figures and drawings.

### BRIEF DESCRIPTION OF THE DRAWINGS

FIG. 1 is a schematic diagram of a front view of an alternative current socket device according to an embodiment of the present invention.

FIG. 2 is a schematic diagram of a rear view of an alternative current socket device according to an embodiment of the present invention.

FIGS. 3-5 are schematic diagrams of the alternative current socket device applied to an electronic device according to an embodiment of the present invention.

### DETAILED DESCRIPTION

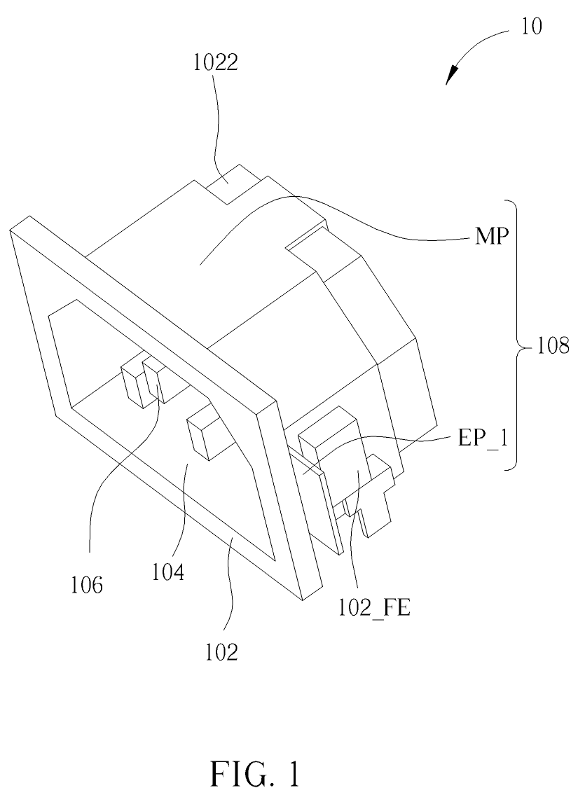

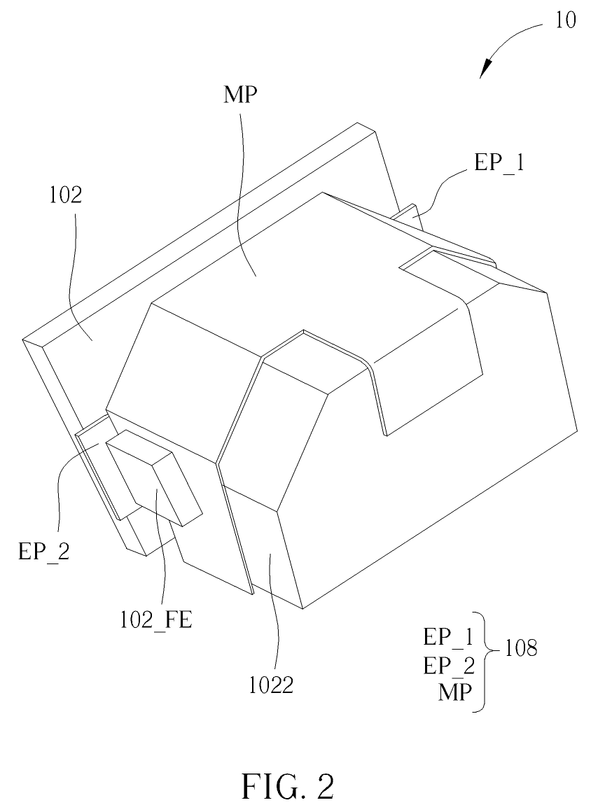

Refer to FIGS. 1 and 2, which are respectively a schematic diagram of a front view and a rear view of an alternative current socket device 10 according to an embodiment of the present invention. The alternative current socket device 10 includes a socket 102, a slot 104, a conductive plug module 106 and a steel piece 108. The alternative current socket device 10 may be applied to an electronic device (not illustrated in FIGS. 1 and 2) . The conductive plug module 106 of the socket 102 is configured to connect an alternating current (AC). The steel piece 108 includes a main part MP, a first extension part EP_1 and a second extension part EP_2, wherein the main part MP is fixed on an exterior of the socket 102 by a fixing element 102_FE on a shell 1022 of the socket 102, and the first extension part EP_1 and the second extension part EP_2 are electrically connected to a conducting point of the electronic device. The steel piece 108 may be a tinplate or steel with tin (SPTE). The fixing element 102_FE may be a tenon, allowing the steel piece 108 to be fixed on the exterior of the socket 102. The alternative current socket device 10 according to an embodiment of the present invention may bypass the current flowing through the main part MP by the first extension part EP_1 and the second extension part EP_2 of the steel piece 108 to reduce an intensity of a short-circuit current of the alternative current socket device 10, such that a current capability of the short-circuit current of the alternative current socket device 10 is over 1500 amperes (A), which conforms to the IEC/EN 62368-1 standard of the International Electrotechnical Commission.

According to the IEC/EN 62368-1 standard of the International Electrotechnical Commission, the earth wire (or the earth conductor) of the socket for receiving AC should sustain the short-circuit current for up to 1500 A. The alternative current socket device 10 according to an embodiment of the present invention utilizes characteristics of the steel piece 108, i.e. a melting point of steel is 1538° C. and a boiling point is 2750° C., and a heat resistance of steel is higher than that of conventional copper foil, to meet the requirements of IEC/EN 62368-1 standard of International Electrotechnical Commission when the current flows through the steel piece 108.

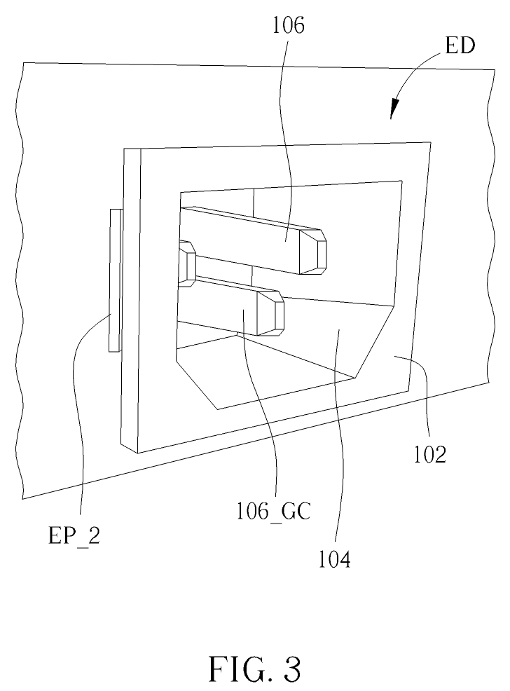

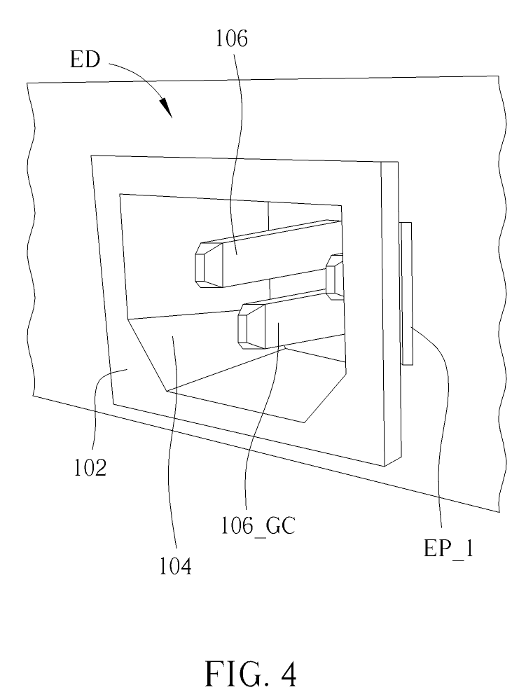

Refer to FIGS. 3 and 4, which are schematic diagrams of the alternative current socket device 10 applied to an electronic device ED according to an embodiment of the present invention. As shown in FIGS. 3 and 4, when the alternative current socket device 10 is installed on the electronic device ED, the first extension part EP_1 and the second extension part EP_2 may be respectively connected to a steel part of the electronic device ED. Notably, a conductive path of the first extension part EP_1 and the second extension part EP_2 according to an embodiment of the present invention is shorter than that of the copper foil when applied to a circuit board.

In addition, the first extension part EP_1 and the second extension part EP_2 of the steel piece 108 of the alternative current socket device 10 are configured to connect the electronic device ED, such that the current will be bypassed to the first extension part EP_1 and the second extension part EP_2 to reduce the current intensity and ensure that the copper foil on the circuit board of the electronic device ED is not burned by heat. In detail, a cross-sectional area of the first extension part EP_1 and the second extension part EP_2 according to an embodiment of the present invention are smaller than a cross-sectional area of a conventional earth conductor of the copper foil on the circuit board. According to a current density formula: J= I/a, wherein “J” denotes the current intensity, “I” denotes the current and “a” denotes the cross-sectional area of the earth conductor, the current intensity and a temperature generated when the current flows through are reduced to improve the safety of the electronic device ED, since the cross-sectional area of the first extension part EP_1 and the second extension part EP_2 are smaller than that of the conventional earth conductor of the copper foil.

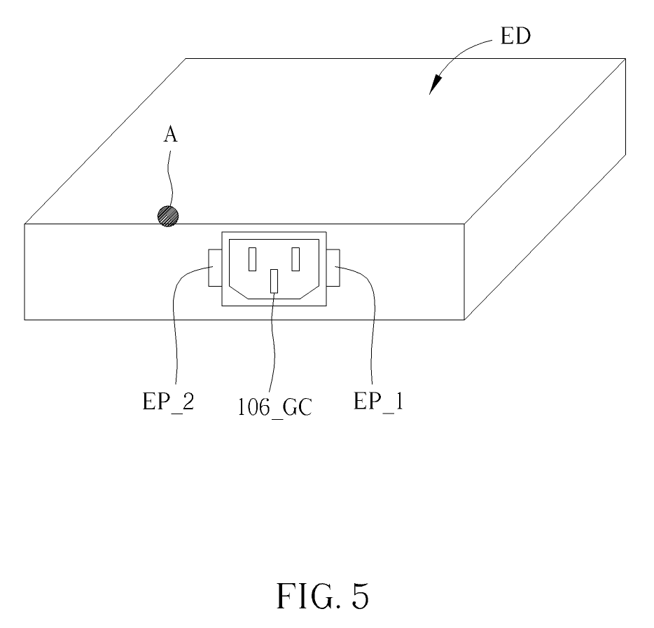

Refer to FIG. 5, which is a schematic diagram of the alternative current socket device 10 applied to the electronic device ED according to an embodiment of the present invention. As shown in FIG. 5, the electronic device ED includes a conducting point A, and the conductive plug module 106 of the alternative current socket device 10 includes an earth conductor 106_GC. When the alternative current socket device 10 is applied to the electronic device ED for examination of the IEC/EN 62368-1 standard, the short-circuit current between the conducting point A and the earth conductor 106_GC is determined. In this case, due to the material characteristics and the current bypass of the first extension part EP_1 and the second extension part EP_2 of the alternative current socket device 10, the requirement for the current capacity of the short-circuit current for over 1500 A may be achieved.

Moreover, since the steel piece 108 of the alternative current socket device 10 is a single piece, when the steel piece 108 is fixed on the exterior of the socket 102, the first extension part EP_1 and the second extension part EP_2 are free from any screws or screw studs to electrically connect the electronic device ED, which reduces the manufacturing cost.

Notably, the embodiments of the present invention illustrated above may be properly modified by people skilled in the art, and are not limited to the above examples. For example, how the steel piece 108 is fixed on the exterior of the socket 102, lengths of the first extension part EP_1 and the second extension part EP_2 are not limited thereto and may be modified according to different requirements.

In summary, the present invention provides an alternating current (AC) inlet device to reduce a current intensity by extension parts of a steel piece, wherein heat resistance is increased due to characteristics of steel, such that the safety of an earth conductor is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An alternating current (AC) inlet device for an electronic device, comprising:
a socket;
a slot;
a conductive plug module, connected to an AC current; and
a steel piece, comprising a main part, a first extension part and a second extension part, wherein the main part is fixed on an exterior of the socket by a fixing element on a shell of the socket, and the first extension part and the second extension part are electrically connected to a conducting point of the electronic device.

2. The AC inlet device of claim 1, wherein the AC inlet device conforms to an IEC/EN 62368-1 standard of the International Electrotechnical Commission.

3. The AC inlet device of claim 1, wherein the first extension part or the second extension part of the steel piece of the AC inlet device does not need any screw or screw stud to be fixed on the electronic device.

4. The AC inlet device of claim 1, wherein an earth short-circuit current of the AC inlet device conforms to a current capability of over 1500 ampere (A).

5. The AC inlet device of claim 4, wherein the conductive plug module of the AC inlet device includes an earth conductor, and the earth short-circuit current is a current flowing through the conducting point of the electronic device via the earth conductor.

6. The AC inlet device of claim 1, wherein a current flowing through the steel piece is bypassed by the main part, the first extension part and the second extension part to reduce an intensity of the current.

7. The AC inlet device of claim 1, wherein the fixing element is a tenon.
